(19) United States
(12) Patent Application Publication
(10) Pub. No.: US 2024/0010537 A1
(43) Pub. Date: Jan. 11, 2024

(54) Systems and Methods for Optimizing Water System Management by Calculating the Marginal Attributes of Water Delivered at Specific Locations and Times

(71) Applicant: The Board of Trustees of the Leland Stanford Junior University, Stanford, CA (US)

(72) Inventors: Meagan Mauter, Palo Alto, CA (US); Yang Liu, Stanford, CA (US)

(73) Assignee: The Board of Trustees of the Leland Stanford Junior University, Stanford, CA (US)

(21) Appl. No.: 18/042,447

(22) PCT Filed: Aug. 9, 2021
(86) PCT No.: PCT/US21/45255

§ 371 Date: Feb. 21, 2023

Related U.S. Application Data
(60) Provisional application No. 63/068,749, filed on Aug. 21, 2020.

(51) Int. Cl. C02F 9/00; G06Q 50/06

(52) U.S. Cl. CPC C02F 9/00; G06Q 50/06

(57) ABSTRACT

Systems and methods for managing and operating a water supply system in accordance with embodiments on the invention are described. In an embodiment, the system calculates a set of one or more marginal values for a water supply system by: determining a set of transmission marginal values for a transmission stage, determining a set of treatment marginal values for a treatment stage, and determining a set of distribution marginal values for a distribution stage for a set of consumers, where the determining includes backtracking consumed water to a set of one or more raw water sources, identifying a set of one or more marginal paths of water supply from each raw water source to the consumer, and quantifying the intensity of inputs associated with the marginal paths.

### CROSS-REFERENCE TO RELATED APPLICATIONS

This application claims priority to U.S. Provisional Application Ser. No. 63/068,749, entitled “Systems and Methods for Optimizing Water System Management by Calculating the Marginal Attributes of Water Delivered at Specific Locations and Times” to Mauter et al., filed Aug. 21, 2020, the disclosure of which is herein incorporated by reference in its entirety.

### FIELD OF THE INVENTION

The present invention is related to providing systems and methods for optimizing water system management by calculating the marginal attributes of water delivered at specific locations and times.

### BACKGROUND

Conventional water supply systems are centralized and consist of interconnected canals, aqueducts, pumps, treatment facilities, water mains, tanks, and pipes that purify, transport, or store water as it is moved from its sources to sites of consumption. As water flows in the interconnected network, there are also virtual flows of a variety of marginal attributes, including embedded energy, chemicals, and other inputs used to produce and deliver clean water to end users. Most conventional methods for assessing and calculating the value of these attributes provide only system-level or pressure-zone-level estimates and only target one specific attribute each. Accordingly, operators of water distribution networks rely on such methods to determine how and where to allocate water resources, which may be suboptimal for a particular situation at a particular time.

### SUMMARY OF THE INVENTION

Systems and methods for optimizing water system management in accordance with embodiments of the invention are illustrated. One embodiment includes a method for managing and operating a water supply system. The method includes steps for calculating marginal and/or time specific and/or location specific cost, energy intensity, carbon intensity, chemical intensity, water quality, value of infrastructure maintenance/upgrade (e.g., fixing pipe leaks), demand response potential, and other attributes that can be traced along the water supply chain. The method separates the water supply chain into stages of transmission, treatment and distribution, backtracks the consumed or stored water to its raw water source(s), identifies the marginal path(s) of water supply from raw water source(s) to the consumer, and quantifies the intensity of inputs associated with the marginal path(s).

One embodiment includes a method for calculating the average attribute of water supply to any subset of the water consumers during any period of time by integrating marginal values over location and time.

In a further embodiment, backtracking inflow for paths from the set of raw water sources to end users includes determining a feasible and/or optimized operating (e.g., pumping) schedule. This could be accomplished using heuristic or non-heuristic methods for determining an operation schedule. This could also be accomplished by referencing against the current operational protocol within a water supply system.

In still another embodiment, backtracking inflow for paths from the set of raw water sources, includes treating each node (e.g., junction, tank, consumer, among others) where two or more links (e.g., pipe, pump, valve, among others) connect with each other as a mixer of upstream inflows. Alternative methods for flow backtracking using experimental tracer data (e.g. fluoride tracers) and other means are also possible.

In a still further embodiment, an inflow is backtracked to a tank that is discharging water, includes backtracking historical flows into the tank prior to the current discharge and treating the tank as a mixer of stored water.

In yet another embodiment, the several devices include pumps, treatment equipment, pipes, valves and other infrastructures that connect water consumers to treatment plants and/or raw water sources.

In a yet further embodiment, when applied to determine the marginal and/or time specific energy intensity of water supply to a specific location, the method includes computing both energy consumption by electrical devices (e.g., pumps) and energy dissipation due to frictional and minor losses along the marginal paths. When calculating the energy intensity of a steady-state device (e.g., aeration chamber in a treatment train) that sits on the marginal path of water supply to a consumer, the per volume energy consumption can be derived from the device's rated power. When calculating the energy intensity of a pump, whose power varies with flow rate and head gain, the real-time per volume energy consumption can be derived by measuring the flow rate and referring the pump curves provided by the pump manufacturer (such curves should indicate the head gain and mechanical efficiency corresponding to each flow rate level). In certain embodiments, the real-time per volume energy consumption can be derived using information from one or more electricity meters that directly measures the electricity consumption rate of a pump.

In many embodiments of the system, when applied to calculate the marginal chemical intensity of water supply, that system can backtrack the chemicals added to the water along the flow paths. The reaction and decaying of chemicals can be neglected here. Because chemicals are usually injected into water at fixed points and at pre-determined rates (e.g., dosage), the backtracking can calculated.

In a further additional embodiment, when applied to calculate the marginal carbon intensity of water supply, the method includes calculating the underlying carbon emission associated with the inputs (e.g., energy, chemical) along the flow paths. Assuming that a system operator can, for example, acquire all of the energy from the electric power grid, then the energy-associated carbon emissions can be computed by multiplying the energy consumption rate with the real-time carbon emission factor of the electricity transmitted to the local substation. In many embodiments, to calculate a chemical-associated carbon emissions, the system can multiply a marginal intensity of chemical use of each consumer with the underlying carbon emissions that is caused by manufacturing one unit volume of the chemical.

In another embodiment again, when applied to calculate a marginal quality of delivered water, the system can include computing the concentration of conservative and non-conservative contaminants, as well as other water quality parameters including physical (e.g., temperature, color, taste, turbidity, among others), chemical (e.g., electrical conductivity, major cations and anions, pH, metals, phosphorus, disinfection byproducts, and organic material, among others), and biological (e.g., fecal coliform, among others) ones. To calculate the concentration of conservative contaminants and the water quality parameters in which, for example no decay or reaction of chemicals take place, the calculation can backtrack water flows and the mixing of flows, which can change the concentration of chemicals along the flow paths over time. In many embodiments, to calculate a concentration of non-conservative chemicals and the water quality parameters in which decaying or reaction of chemicals do take place, a system of differential equations can be used to account for both the movement and decay of chemicals in the spatial and temporal dimensions. By solving a system of differential equations using a finite difference method or other approach, the concentration of any non-conservative chemical can be precisely estimated at any location and time.

In a further embodiment again, when applied to calculate a marginal cost of a water supply, the method can include calculating either or both the operational cost that is associated with the energy, chemical and other time-varying inputs along the flow paths and the fixed cost that can be proportional to the usage of the water supply infrastructure (e.g., treatment plant, pipeline network) along the flow paths. For operational cost, the receiving rate of each input (e.g., energy, chemical) can be calculated at each location (e.g., consumer, location, appliance) and add up the products of such receiving rates with each input's unit cost (e.g., electricity tariff). For fixed cost, the total usage of a component of the infrastructure (e.g., pump, pipe) can be proportional to the total volume of water that passes through the component and each consumer's fractional usage of the component is proportional the fraction of water that passes through the component and is consumed by the consumer. The conversion from this fractional usage to a cost can be based on the depreciation of each infrastructure component as a function of the volume of delivered water. For example, if a $10,000 dollar pump depreciates by $1,000 after delivering (pumping) the first 100 million gallon of water, then an individual consumer would induce a fixed cost of $0.00001 associated with the pump for every gallon of received water that passes through the pump.

In still yet another embodiment, when applied to calculate an electricity demand response potential (e.g., value) of a specific location at a specific time, the method can include calculating energy or energy-associated cost that can be saved or delayed by shedding or shifting water consumption by consumers. For example, for an Urban Water Supply System (UWSS) operator who wants to curtail more electricity load with less impact to the water levels in tanks, the most valuable water consumers to incentivize water load shifting are the ones with highest MEIs during the intended period of demand response. Furthermore, in situations were the pumps in the UWSS may be equipped with variable-speed drives (VSDs), the system operator can backtrack the flows into the high-MEI consumers, identify their upstream pumps, and precisely adjust the discharge rate of each pump to match the expected change in water consumption rates of consumers that are targeted and recruited by the demand response activity.

In a still yet further embodiment, when applied to calculate the water demand response potential (e.g., value) of a specific location at a specific time, the method includes the backtracking of water received at specific locations. For instance, in a fire event, water stored in an adjacent tank would be a critical resource for extinguishing the fire and the system operator of the UWSS would want to incentivize water consumers who received water primarily from the tank to reduce or delay their consumption. In this case, the backtracking method can be used to calculate the fraction of received water at each location that comes from the critical tank for fire suppression. Call this fraction r_{crit}, then the consumers with the highest r_{crit} values should be compensated the most for delaying each gallon of water consumption during the fire event.

In certain embodiments, when applied to calculate the value of infrastructure maintenance or upgrade (e.g., fixing leaked pipes) at a specific location, the method includes integrating the marginal value of the concerned attributes of water that is delivered to or passes through the location over time. For example, if a system operator aims to reduce energy cost by fixing leaked pipes, under a limited budget, the operator should prioritize fixing the pipes through which the leaked water has the highest integrated energy intensities. Since modifications to infrastructure has long-term influence on subsequent operations, the integration of marginal values can be longer real-time values but should be integration of the total volume of otherwise leaked water over the entire operation period after the planned maintenance.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 conceptually illustrates a composition of marginal energy intensity (MEI) and a schematic of a computation in accordance with an embodiment of the invention.

FIG. 2 conceptually illustrates an example of a layout of a water distribution network WDN and a daily average MEI of its water consumers in a base case scenario.

FIG. 3 conceptually illustrates an electricity price pattern EPO in accordance with an embodiment of the invention.

FIG. 4 conceptually illustrates calculating a daily average MEI values of the consumers in the single-source UWSS in accordance with an embodiment of the invention.

FIG. 5 illustrates an MEI-based decision framework for selecting energy-optimal locations for DWRS deployment in accordance with an embodiment of the invention.

FIG. 6 illustrates a daily average marginal energy intensity (MEI) across a 10,000+ node water supply system drawing on six diverse water sources (including desalination, non-potable reuse, surface, and groundwater) in accordance with an embodiment of the invention.

FIG. 7 illustrates drivers of the daily average marginal energy intensity (MEI) of water supply in a city network in accordance with an embodiment of the invention.

FIG. 8 illustrates a backtracking process for computing various marginal attributes of water supply in an interconnected pipeline network in accordance with an embodiment of the invention.

FIG. 9 illustrates a process for managing and operating a water supply system in accordance with an embodiment of the invention.

FIG. 10 illustrates a computer system for optimizing water system management by calculating marginal attributes of water delivered at specific locations and times in accordance with an embodiment of the invention.

### DETAILED DESCRIPTION

Turning now to the drawings, systems and methods for optimizing water system management by calculating marginal attributes of water delivered at specific locations and times in accordance with many embodiments of the invention are described. As noted, water flows can include flows that include embedded energy, chemicals, and other inputs to produce and deliver clean water to end users. In many embodiments of the system, by tracing the virtual flows, including the embedded energy, chemicals, and other inputs of a water supply in a network, processes in accordance with many embodiments of the invention can capture many attributes of water supply that are important to a system operator and/or software application that can use such information to optimize and/or determine water distribution. For instance, for a system operator seeking to reduce the carbon intensity of water supply, the carbon emissions associated with the virtual flows of energy and chemicals can serve as an informative metric. However, conventional methods for assessing such attributes provide only system-level or pressure-zone-level estimates and may only target one specific attribute each. Accordingly, systems and methods in accordance with a number of embodiments of the invention provide a multi-purpose computational framework that can calculate the marginal attributes of the delivered water by backtracking the water delivered at any specific location (e.g., down to the tap or appliance level) and time to its source(s). Methods in accordance with numerous embodiments of the invention can support the assessment of various attributes, such as (but not limited to) the intensity of energy use, chemical use, embedded carbon emissions, the cost of water supply, the water quality, the value of location-specific water efficiency upgrades, the value of location-specific maintenance or leak reduction upgrades. In a number of embodiments, methods can determine the electricity grid demand response (EG-DR) potential and the value of that DR realized by not consuming water and thus not consuming electricity to provide that water. In various embodiments, processes can determine the water grid demand response potential (WG-DR) that would stabilize the water grid against low pressure under periods of excessively high demand (e.g., fire, drought, among other situations) by not consuming water at that specific location and time. Methods in accordance with a number of embodiments of the invention can enable multi-attribute characterization and optimization of the water system across one or more of these attributes.

Systems and methods in accordance with a variety of embodiments of the invention can implement a backtracking method that traces the water flow from sources to an end user (e.g., taps, non-consumer junctions, and/or any other point in a pipeline network). Although many of the examples described herein describe processes in the context of assessing marginal energy intensity (MEI), one skilled in the art will recognize that similar systems and methods can be used in a variety of applications, including (but not limited to) chemical use, embedded carbon emissions, the cost of water supply, the water quality, the value of location-specific upgrades or maintenance, EG-DR, WG-DR, etc., without departing from this invention. Similarly, although many of the examples are described with reference to an urban water supply system (UWSS), one skilled in the art will recognize that similar systems and methods can be used in a variety of applications, such as (but not limited to) water supply systems in urban, agricultural, and industrial settings.

Prior art techniques to assess the energy intensity of delivered water have used numerical techniques included calculating the energy intensity of water supply at the spatial resolution of individual pressure zones using a method that traces received water to its sources. To provide improved calculations, many embodiments of the system can also account for frictional and minor losses in pipes, which can significantly influence an energy footprint of water supply to individual consumers, as well as various other attributes described throughout including water quality.

Furthermore, many embodiments of the system can handle tanks that store and discharge water and are integral to continuous system operation. In many embodiments, energy can be treated as a conservative property (e.g., like the concentration of a conservative chemical) and thus can be used by certain available functions and/or water simulation software (e.g., EPANET's function) that simulate the flow of chemicals to calculate the energy intensity of water supply as a ‘concentration of energy’. However, the numerical treatment of energy as a conservative property can make it fundamentally incapable of identifying the optimal water system design or operation. First, a user of a water model distribution and simulation software, such as EPANET-based methods, may have to specify a constant or a timeseries of pre-determined energy intensity of each pump before running the simulation, which can ignore the fact that the energy intensity of a pump can vary significantly with its operating status (e.g., flow rate, efficiency, among others). Assuming the inherently time-varying operating status of each pump to be static or known can result in a large distortion of the results and sub-optimal operation of the water system. Also, certain prior approaches can be unable or incapable of including frictional and minor losses in the calculation of energy intensity because such losses vary with flow rates and may not be pre-specified as a concentration. These same computational limitations can impede the determination of the other time and location specific water attributes described.

Systems and methods in accordance with certain embodiments of the invention can utilize a metric called the marginal energy intensity (MEI) to calculate the true energy intensity of a water supply and apply methods that precisely calculate the full source-to-consumer energy footprint of water supply at the scale of a single node or link in different multi-source water supply systems. In particular, processes in accordance with numerous embodiments of the invention can backtrack water discharged from tanks to its original sources without treating energy as the concentration of a chemical that is being fed at a constant rate at certain locations. In addition, systems in accordance with several embodiments of the invention can incorporate one or more optimization components that can identify a least-cost operation schedule, which can produce MEI values that reflect the scenario of the least-cost operation. In numerous embodiments, if an objective other than cost were desired as a baseline, the system could also be optimized on that variable. Systems and methods in accordance with various embodiments of the invention can use MEI in a variety of different applications, such as (but not limited to) setting efficient spatial, temporal, and elevation-specific variable water prices, prioritizing and informing the value of water efficiency upgrades (such as, but not limited to, distributed or centralized water reuse upgrades), and/or determining the magnitude and/or value of electricity grid or water demand response participation by water end users and utilities.

### Marginal Energy Intensity (MEI) of a Water Supply

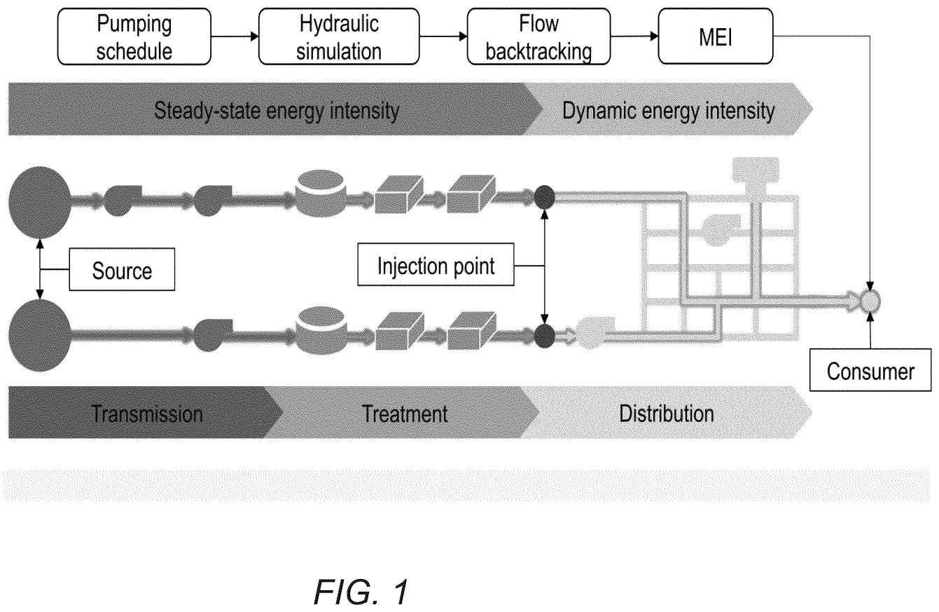

In many embodiments, a marginal energy intensity (MEI) of a water supply can be calculated. FIG. 1 illustrates a composition of MEI and a schematic of a computation in accordance with an embodiment of the invention. The MEI can include three components associated with the transmission, treatment, and distribution of water. In certain embodiments, the different components can be assumed to be either a steady-state or a non-steady state transmission of water. In many embodiments of the system, a location- and/or time-specific MEI value of a given consumer can be calculated by backtracking the inflow to its injection points in the WDN and thereafter to the raw water sources. Backtracking in accordance with a variety of embodiments of the invention can utilize a simulation of water flows in the WDN under a feasible operation schedule.

In certain embodiments, as energy-consuming components in a UWSS are generally not dedicated to a single water consumer, processes in accordance with certain embodiments of the invention can calculate MEI by disaggregating energy consumption. FIG. 1 illustrates a conventional UWSS that includes 3 stages—transmission, treatment, and distribution. Therefore, a first dimension of disaggregation in accordance with many embodiments of the invention can be to decompose MEI into three components associated with the three stages. Since water transmission is typically either synchronized with steady-state and/or non-steady state treatment operations or behaves as a slow temporal-scale phenomenon, both water transmission and treatment can be approximated by a steady-state model(s) and/or a non-steady state model(s) in accordance with some embodiments of the invention. In many embodiments, water transmission and treatment can be non-steady state and can be approximated with non-steady state models.

As illustrated in FIG. 1, steady-state models in accordance with numerous embodiments of the invention intersect with the dynamic model for water distribution at injection points, where treated water can be injected into a water distribution network (WDN). Following a modeling framework, in some embodiments, the pre-injection energy intensity associated with each injection point can be treated as a known constant that can depend on the steady-state and/or non-steady state operation of water transmission and treatment. Unlike water transmission and treatment, distribution of purified water can be inherently time-varying and may consume fluctuating electricity load. For example, given a set of hourly electricity prices and a forecast of water demand, a rational UWSS operator can schedule the pumping operations to minimize the operating cost while maintaining the quality of water supply. Systems and methods in accordance with certain embodiments of the invention can implement one or more optimization processes (such as, but not limited to simulated annealing) to optimize an operation schedule (e.g., a daily schedule with hourly resolution).

In addition to the disaggregation of energy use by stage of water supply, processes in accordance with certain embodiments of the invention can perform disaggregation to decompose the water received by each consumer by source. To facilitate such disaggregation, processes in accordance with many embodiments can perform backtracking processes that can calculate the amount of water received from each source by each consumer during each time step. Backtracking processes in accordance with many embodiments of the invention are described throughout this description. In a variety of embodiments, backtracking can assume that each node in the WDN behaves as a mixer of upstream water and passes mixed water to the downstream. In the process of backtracking, processes in accordance with various embodiments of the invention can identify energy-consuming devices (e.g., pumps, treatment processes, pipes, valves, etc.) along the paths between each pair of source and consumer. In many embodiments, although the energy dissipated by the passive devices (e.g., pipes, valves) can be usually a small fraction of the energy consumed by the electrical devices, processes in accordance with certain embodiments of the invention can include passive devices in the calculation of MEI to capture more of an energy footprint along the paths of water supply. By adding up the energy intensities of the identified devices, the MEI value of each consumer can be computed.

Unlike energy storage, which can still play a role in power supply and can be modeled as a price-taker in the electricity market, tanks (e.g., water storage) in a WDN can be the primary sources of water supply during hours when some or all pumps are off. As illustrated in FIG. 1, a tank can function as an injection point, which injects pre-pumped water to the rest of the WDN. To account for the energy consumed to fill up tanks in previous time periods, processes in accordance with a variety of embodiments of the invention can calculate a time averaged pre-injection energy intensity of each tank as a constant whose value can depend on where the stored water comes from. In many embodiments, if information about the composition of stored water in terms of its source(s) at the beginning of the simulated period is known, the system can compute the real-time pre-injection energy intensity of each tank from a dynamically updated water composition.”

### Multi-Source Urban Water Supply Systems

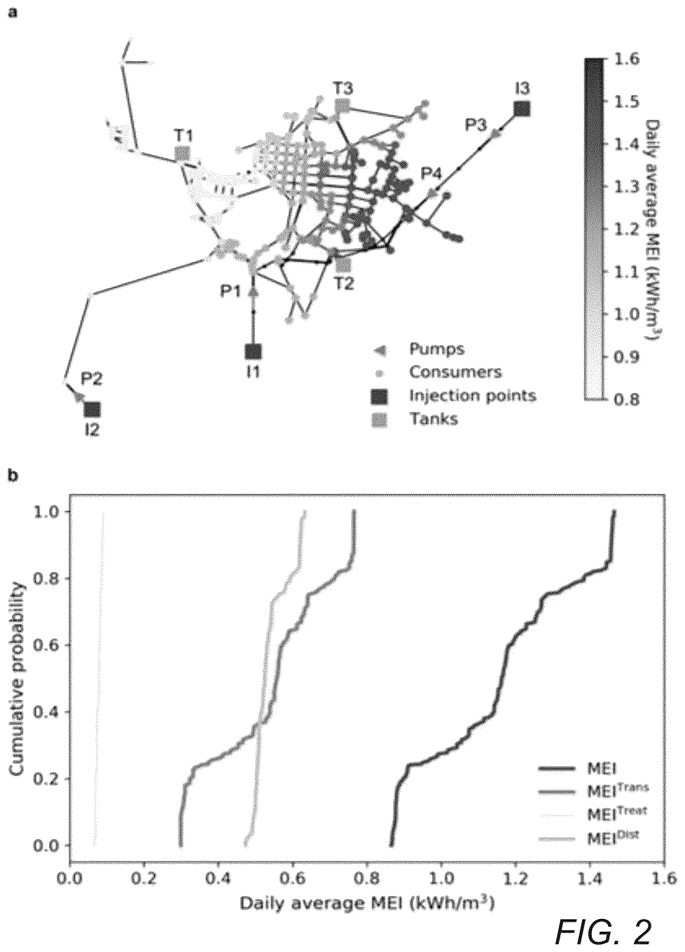

In many embodiments, the system can be applied to a multi-source UWSS. FIG. 2 illustrates an example of a layout of a WDN and a daily average MEI of its water consumers, 330 in this particular example, in a base case scenario. As illustrated, the WDN has a number of pumps (e.g., 4 pumps P1-P4), a number of injection points (e.g., 3 injection points I1-I3), which correspond to a local groundwater source, a local surface water source, and a distant source that involves inter-basin water transfer, respectively, and a number of tanks (3 tanks T1-T3). The pre-injection energy intensities of the three injection points can be set to be a particular value (e.g., 0.4 kWh/m³, 0.11 kWh/m³, and 1.05 kWh/m³), respectively. In many embodiments, the pre-injection energy intensities can be chosen from the suggested values for different sources. The lengths of ultra-long pipes immediately downstream I3 can be shortened for better visualization. The graph illustrates an example of the disaggregation of the daily average MEI of the 330 consumers into the components associated with the transmission, treatment, and distribution of water. The network can be a skeletonized network where each consumer shown in FIG. 2 may represent a cluster of consumers in the un-skeletonized WDN.

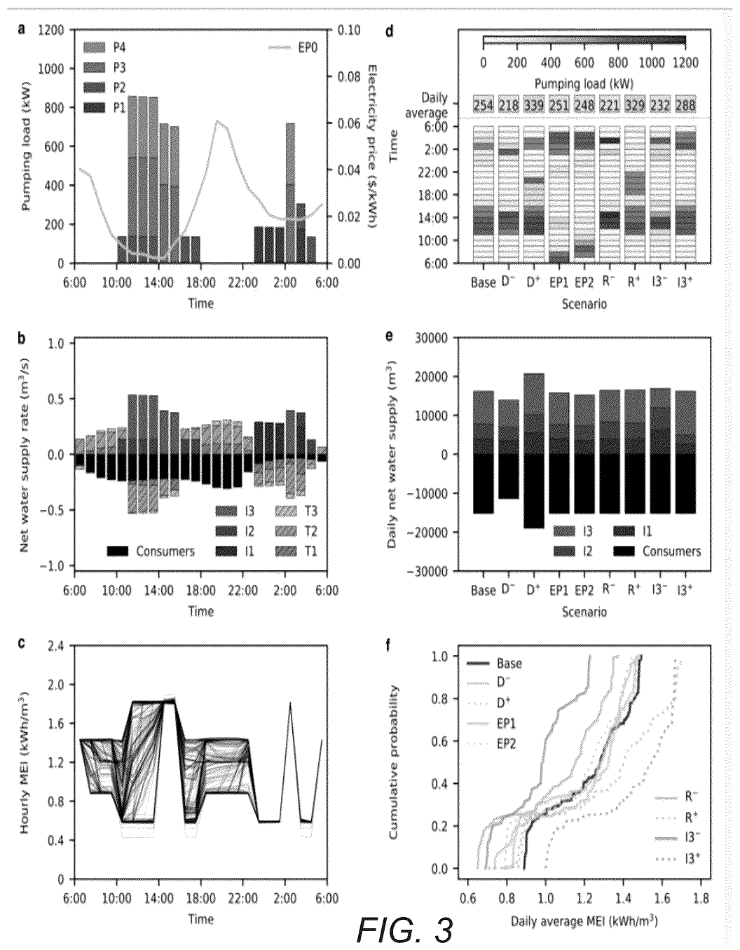

In the base-case scenario of the example illustrated in FIG. 2, a target fraction of daily injection through I1, I2 and I3 can be set to be a particular value (e.g., 25%, 25% and 50%, respectively). FIG. 3 illustrates an electricity price pattern EPO in accordance with an embodiment of the invention.

Under electricity price pattern EPO, as is shown in FIG. 3, pumping activities can be optimally scheduled to take place during certain hours (e.g., 11:00-18:00, 23:00-2:00, and 4:00-6:00). While some or all of the different injection points can be directly contributing to the water supply between certain hours, injection through a particular injection point (e.g., I3) can be desynchronized from injection through other injection points (e.g., I1 and I2) in the remaining pumping hours.

As illustrated in FIG. 3, whether injection through a particular injection point (e.g., I3) is synchronized with injection through other injection points (e.g., I1 and/or I2) can have a significant effect on the real-time MEI values. When synchronized, the MEI values can span across a wide spectrum; when not synchronized, the spectrum can be condensed to a narrow band. Accordingly, the spread of MEI values can be wider when water is injected through multiple injection points simultaneously and can be narrower when consumers receive water from a single source or sources from which the flow paths are similar in terms of their energy footprint.

As illustrated in the example provided in FIG. 3, when all pumps are off, the demand in the WDN can be solely met by tanks. During such periods (e.g., 6:00-11:00, 18:00-23:00 and 2:00-4:00), the MEI values can be clustered around 3 horizontal levels. The 3 levels reflect the pre-injection energy intensities of the 3 tanks and a fluctuation of MEI between the levels can represent a change in the composition of received water in terms of its sources (or injection points). Since the tanks can mix water from all 3 sources, consumers who receive more water from tanks may have less extreme MEI values than those who only receive water from a high- or low-energy intensity source. In general, the spread of the MEI values can be an indicator of a similarity in source-to-consumer flow paths among consumers.

In certain embodiments, hourly MEI values can be weighted with an hourly water consumption of individual consumers to determine the daily average MEI values. An example of daily average MEI values of consumers in accordance with an embodiment of the invention are illustrated in FIG. 2. In this example, due to the high pre-injection energy intensity of I3, the consumers most likely to receive water from I3 can have the highest daily average MEI values. Likewise, the upper-left cluster of consumers can have the lowest daily average MEIs because they are least likely to receive water from I3.

FIG. 2 illustrates a stage-wise daily average MEI values in the base-case scenario in accordance with an embodiment of the invention. The cumulative distribution functions (CDF) illustrated in FIG. 2 show that the transmission- and distribution-associated components can dominate overall MEI values and can be larger than a treatment-associated component. However, if any energy-intensive unit process such as reverse osmosis is adopted, the treatment stage may account for a larger fraction in the MEI values. Although FIG. 2 illustrates MEI values for a particular multi-source UWSS, any of a variety of different MEI and/or attribute values for multi-source UWSS can be calculated as appropriate to the requirements of specific applications in accordance with embodiments of the invention.

### Sensitivity Analysis of MEI

To identify factors that may influence an underlying energy intensity of water supply at the level of individual consumers, processes in accordance with various embodiments of the invention can perform a sensitivity analysis, including by varying the water demand, electricity price, pipe roughness, and/or the daily injection from one or more sources. In the example illustrated in FIG. 3, the optimal pumping load profile and source-specific daily water injection volumes can be calculated for each scenario. Daily average MEI values for the consumers can be insensitive to changes in water demand (scenarios D⁻, D⁺) and the temporal shift of pumping load due to changes in the electricity price pattern (scenarios EP1 and EP2). These scenarios can have little influence on the energy intensity of the flow paths from the injection points to the consumers, but instead can influence the duration and timing of the periods in which each source-to-consumer path is activated to transport water.

In contrast, daily average MEI values can be sensitive to pipe roughness (a proxy for network size). According to the Hazen-Williams equation when the roughness of a pipe increases by 50% (e.g., roughness coefficient decreases by 33.3%), the head loss can increase by 112% with all else held equal. In scenario Pipe⁺, a 50% increase in roughness can correspond to an average daily MEI increase of 14.9% (0.18 kwh/m³). Besides the additional energy dissipated in pipes, the increased head losses can also force the pumps to run at higher operating heads and lower discharge rates, which can cause the pumps to suffer lower mechanical efficiencies (e.g., ratio between energy delivered to water and energy consumed by the pump).

Daily average MEI values can be sensitive to the injection energy of the source. Representing both the transmission and treatment of waters, this value can be influenced by the availability and quality of a particular water supply. In the example illustrated in FIG. 3, I3 is the most energy-intensive injection point. Therefore, as the daily injection through I3 is decreased and increased in scenarios I3⁻ and I3⁺, respectively, the MEI values shift the most from the base-case scenario. Such shifts reflect the changes in the frequency at which each consumer receives water from I3.

Besides the horizontal shift of the cumulative distribution functions (CDFs), the CDFs may not be perfectly parallel and vary in their slopes. For example, the CDF of scenario Pipe⁻ can have the steepest slope, which suggests that the hourly MEI timeseries of individual consumers are more often condensed to a narrow band (e.g., 11:00-2:00) than spread over a wide spectrum (e.g., 12:00-15:00). In addition, the steep slope can also be caused by the reduced operating heads of pumps P3 and P4, which can shrink the gap between energy intensities of flow paths through I3 and those through either I1 or I2.

In addition to the aforementioned factors influencing MEI values, water leakage can be common in water distribution systems. In many embodiments of the system, the computational framework may not differentiate between leaked water and consumed water, the D⁺ scenario illustrated in FIG. 3 can be representative of water leakage distributed across the entire system and equal to 25% of the system-wide water demand. In scenario D⁺, an operator may be aware of water leakage and can adjust the operation schedule to compensate. The result is a negligible change in system-wide MEI values, with the change at each node of variable magnitude and direction. When the leakage is sudden and specific to select components (e.g., pipes), the impact on MEI values can be captured in the perturbation analysis. That analysis can increase the water demand of a small number (e.g., ≤5) of consumers and re-computes the MEI values under the base case operation schedule. The changes in MEI values of perturbed consumers may also be very limited (e.g., <6%), but a higher leakage rate may induce larger deviations in MEI due to more dramatically shifted water flow patterns.

### Relationship Between MEI and Elevation

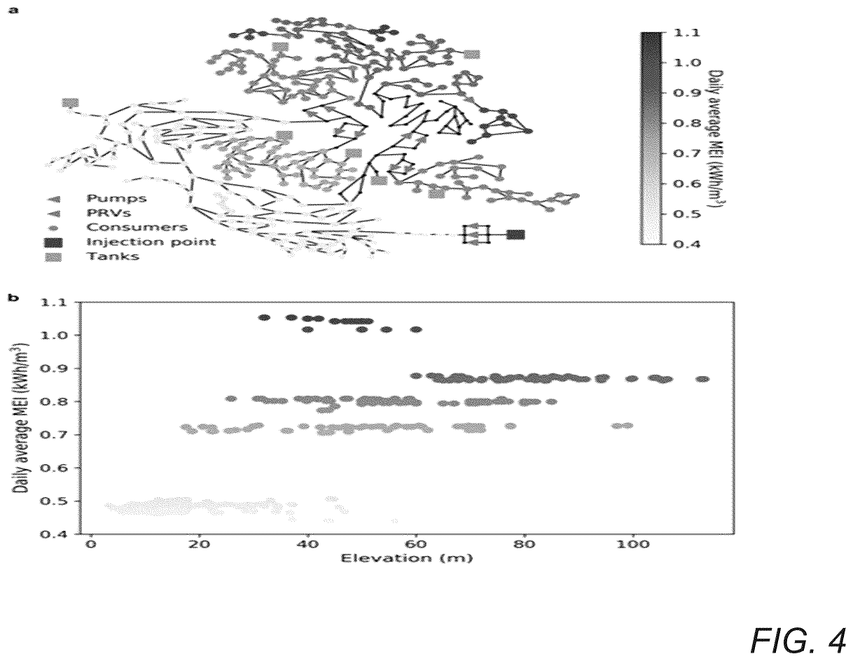

In a large city where the elevations of water consumers vary significantly (e.g., San Francisco), the UWSS can be typically divided into pressure zones separated with devices that only allow single-direction flows (e.g., pump, check valve). In order to deliver water with sufficient pressure to high-elevation consumers, booster pumps are often used. To explicitly demonstrate the relationship between a consumer's elevation and its MEI value, processes in accordance with a number of embodiments of the invention can be applied to a single-source UWSS, as illustrated in FIG. 4 in accordance with an embodiment of the invention. As illustrated in the example in FIG. 4, the pre-injection energy intensity is 0.3 kWh/m³.

Under an operation schedule optimized with electricity price pattern EPO, the daily average MEI values of the consumers in the single-source UWSS can be calculated as illustrated in FIG. 4. As illustrated, the MEI values form different clusters (e.g., 5 clusters—except the top cluster, MEI>1.0 kWh/m³), the other four clusters show a generally positive correlation between MEI and elevation from an inter-cluster perspective. However, within each cluster, consumers with similar MEI values can still span across a wide range of elevations. Such observation can be explained by FIG. 4, the clusters can be mainly formed by the locations of consumers relative to the booster pumps, whose sizes (e.g., operating head) can be mostly determined by the overall elevation of downstream consumers relative to the upstream. Even if a specific consumer is located at low elevation, its MEI may be high if it is co-located with other high-elevation consumers who may require a larger booster pump for proper water supply. The top cluster in the example in FIG. 4 results from the energy dissipation by pressure-reducing valves (PRVs) that are placed to prevent main burst in downstream pipes. As shown in FIG. 4, this cluster of consumers may be located around three dead ends downstream of three PRVs. In this WDN example, the locations of these dead-end consumers can be least favorable in terms of energy-efficient water delivery—they are distant and low-elevation consumers downstream of high-elevation ones. For these consumers, the water pressure gained at the booster pumps can become a burden that should be addressed.

In general, elevations of consumers in a UWSSs can influence the optimal locations and sizes of booster pumps, which subsequently can determine the resulting MEI values of the downstream consumers. In addition, the relationship between MEI and elevation can be compounded by the energy dissipation in pipes and valves.

In many embodiments, an MEI, or the time-varying energy intensity of water delivery to a specific location, can be a metric for informing water portfolio management. Since the water consumption rate of a single consumer can be marginal (or negligible) compared to the total injection rate or flow rate in a water main, MEI in accordance with several embodiments of the invention can be inherently insensitive to perturbations in the water consumption behavior of a small number of consumers. As a result, in many embodiments, MEI can be utilized as the primary energy metric when evaluating operational protocols, alternative water sources, and/or infrastructure retrofits.

Regarding operational protocols, MEI in accordance with some embodiments of the invention can be applied to improve the energy efficiency of a UWSS. For instance, consumers with high real-time MEI values can be exploited as ideal targets for aggregating demand response (DR) capacity. In the past, UWSSs have been identified as ideal participants for DR provision due to their large pumping load and large water storage capacity. However, prior research focused on decoupling water supply and demand through storage and may not include the temporal flexibility in water demand. In a UWSS with less storage capacity, for example, if high-MEI consumers shift their water consumption temporally, the pumps can shift their load accordingly without putting the continuity of water supply at risk due to low tank levels. In particular, in certain embodiments, MEI can be used to identify consumers who can contribute most to load shifting by shifting water consumption.

In certain embodiments, MEI can be an informative metric when choosing locations to utilize alternative water sources (e.g., rainwater) or to initiate infrastructure retrofit (e.g., pipe replacement). For instance, if a UWSS operator decides to subsidize a small number of water consumers to deploy decentralized water recycle (DWR) while minimizing the additional energy use, then the consumers with highest MEI values evaluated over an extended simulation period (e.g., a year) can be the most energy-efficient locations for the next batch of DWR deployment. After such consumers deploy DWR and reduce their water withdrawal from the WDN, the pumps previously contributing to their water supply can reduce flow rates and power consumption. Such active reduction in pump discharge may benefit from precision, which can be made possible by equipping the pumps with variable-frequency drives. If previous MEI values of the consumers who adopt DWR are higher than the energy intensity of operating DWR, then a net energy saving can be achieved for the UWSS.

By attributing the total energy consumption by a UWSS to individual consumers, systems and methods in accordance with various embodiments of the invention could serve as a decision-tool that informs policy-makers who aim to upgrade the infrastructure or refine the operational protocol of the aging water supply systems in an incremental manner. Given the aforementioned advantages and potential applications, MEI in accordance with some embodiments of the invention can be used to investigate the energy-water nexus in urban environments at the micro-scale (e.g., individual appliances, households, buildings, and communities etc.).

### Operation Schedules

One or more different operation schedules can be sufficient for computing MEI using the computational framework in accordance with several embodiments of the invention. However, to enable a rigorous sensitivity analysis, processes in accordance with several embodiments of the invention can implement a heuristic optimization method (e.g., simulated annealing) to solve for near-optimal operation schedules that minimize electricity costs. In several embodiments, processes can use one or more penalty functions to reflect other common factors in WDN pump scheduling. Examples of penalty functions can include (but are not limited to) penalizing solutions with: final tank water levels lower than initial levels to encourage water supply reliability, excessive pump startups (e.g., >4 per day) to avoid additional wear to the mechanical systems and increased maintenance costs, water delivery at <20 psi, and/or large deviations (e.g., >2%) from the planned percentage of water injection through each injection point to ensure long-term reliability of water supply.

In some embodiments, hydraulic constraints for pump scheduling can be handled utilizing simulation software, such as (but not limited to) EPANET software. In particular, the simulation software can use a defined pumping schedule to simulate hydraulics in a water network. The hydraulic simulator can apply an iterative backward Euler method to calculate the flow rate of each link (e.g., pump, valve, pipe, among others), the total head (e.g., the sum of elevation and pressure, among others) of each node, and the operating status (e.g., flow, head gain, mechanical efficiency, among others) of each pump. In many embodiments, simulated values can be input to backtracking algorithms in accordance with several embodiments of the invention as described herein.

### Flow Backtracking

Flow backtracking in accordance with certain embodiments of the invention can include backtracking water received by one or more consumer to its sources, as set forth by Eq. 1a-4a below, and/or backtracking the energy consumption or dissipation along the flow paths backtracked in the first step (Eq. 5a-6a). In Eq. 1a, i, j, t are indices of injection points, nodes in a WDN, and time steps, respectively. The MEI components associated with the transmission, treatment, and distribution of water are labeled as MEIᵢ^{Trans} MEIᵢ^{Treat}, and MEI_{i-j,t}^{Dist}, which add up to MEI_{j,t}, the consumer- and time-specific MEI value. Assuming MEIᵢ^{Trans} and MEIᵢ^{Treat} to be constants for each injection point throughout the simulated time horizon, their sum can be represented as one constant MEIᵢ^{Pre-inj} (Eq. 2a). Besides the disaggregation of energy by stage of water supply, Eq. 1a also demonstrates the disaggregation of energy by source of water−r_{i-j,t} is the fraction of water received by consumer j during time step t that comes from injection point i.

MEI_{j,t}=Σi^{r}^{_{i-j,t}}·(MEIᵢ^{Trans}+MEIᵢ^{Treat}+MEI_{i-j,t}^{Dist}) (1 a)

MEIᵢ^{Pre-inj}=MEIᵢ^{Trans}+MEIᵢ^{Treat} (2a)

Assuming each node in a WDN to be a perfect mixer of upstream water, r_{i-j,t}, in accordance with many embodiments of the invention can be calculated from the values of r_{i-k,t}, where k is the index of node j's immediate upstream nodes (Eq. 3a). In Eq. 3a and 4a, Kⱼ is the set of immediate upstream nodes of node j, Q_{k-j,t} is the flow rate from node k to node j, and Q_{j,t} is the total inflow rate at node j. It is worth noting that Qₜ is not necessarily the water consumption rate at node j. In a variety of embodiments, to solve the system of equations represented by Eq. 3a, the injection points can be used to create boundary conditions (e.g., r_{i-i,t}=1 if injection point i is actively injecting water).

$$k ∈ {K}_{j} {r}_{i - j , t} = {\sum }_{k} {r}_{i - k , t} \cdot \frac{{Q}_{k - j , t}}{{Q}_{j , t}} \qquad ( 3 a )$$

$${Q}_{j , t} = {\sum }_{k} {Q}_{k - j , t} \qquad ( 4 a )$$

Once the values of r_{i-j,t} are calculated, the next step can be to calculate MEI_{i-j,t}^{Dist}, whose value is time-varying. If the absolute value of the head difference across nodes k and j is defined as h_{k-j,t}, which can be directly retrieved from the simulation results, MEID_{i-j,t}^{Dist} can be solved for with Eq. 5a and 6a. In Eq. 5a, H_{i-j,t}, is sum of h_{k-j,t} values along the path(s) from injection point i to node j. It is worth noting that h_{k-j,t} for a pump in this example equals the product of the actual head gain and the inverse of the mechanical efficiency. Similar to r_{i-i,t}, the calculation of H_{i-j,t} in accordance with a variety of embodiments of the invention can propagate from upstream nodes to downstream nodes and require boundary conditions at injection point (i.e., H_{i-i,t}=0).

$${MEI}_{i - j , t}^{Dist} = ρ \cdot g \cdot {H}_{i - j , t} \qquad ( 5 a )$$

$$( 6 a )$$

$$k ∈ {K}_{j} {H}_{i - j , t} = \frac{1}{{\sum }_{k} {r}_{i - k , t} \cdot {Q}_{k - j , t}} \cdot {\sum }_{k} {r}_{i - k , t} \cdot {Q}_{k - j , t} \cdot ( {H}_{i - k , t} + {h}_{k - j , t} )$$

Since every node has its H_{i-j,t} value, MEI in accordance with certain embodiments of the invention can be calculated for all nodes, including those that are not consumers (e.g., zero-demand junctions, tanks). For such non-consumer nodes, their MEI values (e.g., as calculated using Eq. 1a-6a) can be interpreted as the energy intensity that would be incurred if a consumer connected to the node withdraws water. For a tank that is receiving water and saving the water for later injection, such non-consumer MEI can be seen as its real-time pre-injection energy intensity.

### Pre-Injection Energy Intensity of a Tank

There may be certain challenges in calculating the pre-injection energy intensity of a tank. A challenge can be the temporal decoupling of the charging and discharging of tanks—the consumption of energy to fill up a tank takes place before the tank functions as an injection point. Secondly, assuming each tank to be a perfect mixer, this calculation may need the backtracking of the entire volume of water stored in the tank. Since some water in a tank may be pumped into it before the simulated time horizon (unless all tanks are empty at t=0), it may not be feasible to backtrack the entire volume of stored water without assuming an arbitrary initial condition. In many embodiments, as noted above, if information about the composition of stored water in terms of its source(s) at the beginning of the simulated period is known, the system can compute the real-time-pre-injection energy intensity of each tank from a dynamically updated water composition.”

To address these issues, processes in accordance with certain embodiments of the invention may only backtrack the flows into a tank during a simulated time horizon and can use a weighted average MEI (e.g., non-consumer MEI) of such inflows as a proxy for the true pre-injection energy intensity. In Eq. 7a below, T is the set of tanks and R is the set of reservoirs of treated water (i.e., non-tank injection points). It is worth noting that MEIᵢ^{Pre-inj} in Eq. 7a is not necessarily associated with a non-tank injection point because a tank may receive water from another tank. In Eq. 8a, Q_{n,t} is the inflow rate at tank n during time step t and Qₙ is the total inflow in the entire simulated time horizon.

$$n ∈ T {MEI}_{n}^{Pre - inj} = {\sum }_{t} \frac{{Q}_{n , t}}{{Q}_{n}} {\sum }_{i} {r}_{i - n , t} \cdot ( {MEI}_{i}^{Pre - inj} + {MEI}_{i - n , t}^{D i s t} ) \qquad ( 7 a )$$

$$i ∈ ( T ⋃ R ) ∖ n {Q}_{n} = {\sum }_{t} max \{ {Q}_{n , t} , 0 \} \qquad ( 8 a )$$

Such approximation approaches in accordance with numerous embodiments of the invention can eliminate the need to assume an arbitrary initial condition for the pre-injection energy intensity of each tank. In addition, if the net water supply throughout the simulated time horizon is 0 for each tank, the computed MEI values, when multiplied with the consumption rates of water, will sum up to the total energy consumption and dissipation in the UWSS in the simulated time horizon.

In many embodiments, in addition to computing an MEI, the system can be adapted to calculate numerous different attributes (e.g., marginal chemical intensity, marginal computation intensity, quality of water delivered, among others). These attributes may be combined to inform multi-objective optimal water system management.

When calculating the marginal chemical intensity of water supply, processes in accordance with numerous embodiments of the invention can backtrack chemicals added to the water along the flow paths. When focusing on calculating the consumption of chemicals, the reaction and decaying of chemicals can be neglected.

When calculating the marginal carbon intensity of water supply, processes in accordance with certain embodiments of the invention can calculate the underlying carbon emissions associated with the inputs (e.g., primary energy and associated direct emissions from fuel combustion, marginal carbon intensity from electricity consumption, embedded carbon emissions of chemicals consumed in water treatment, among others) along the flow paths. For example, assuming that a system operator acquires all of the energy from an electric power grid, then the energy-associated carbon emissions can be computed by multiplying the energy consumption rate with the marginal carbon emission factor (e.g., real-time carbon emission factor of the electricity transmitted to the local substation). To calculate the chemical-associated carbon emissions, the marginal intensity of chemical use of each consumer can be multiplied with the underlying carbon emissions that is caused by manufacturing one unit volume of the chemical.

When calculating the marginal quality of delivered water, processes in accordance with a variety of embodiments of the invention can compute the concentration of conservative and non-conservative contaminants, and/or other water quality parameters such as (but not limited to) physical (e.g., temperature, color, taste, turbidity, among others), chemical (e.g., electrical conductivity, major cations and anions, pH, metals, phosphorus, disinfection byproducts, organic material, among others), and biological (e.g., fecal coliform, among others) ones.

In many embodiments, to calculate the concentration of conservative contaminants and the water quality parameters in which no decaying or reaction of chemicals take place, the calculation in accordance with certain embodiments of the invention can backtrack water flows and the mixing of flows, which change the concentration of chemicals along the flow paths over time.

To calculate the concentration of non-conservative chemicals, chemicals that are released by components of the distribution system, and water quality parameters in which decay or reaction of chemicals do take place, processes in accordance with some embodiments of the invention can use the Streeter-Phelps formula or similar approaches to account for the generation, movement, and decay of chemicals in spatial and temporal dimensions. By solving the 2-D Streeter-Phelps equations with the finite difference method, processes in accordance with a number of embodiments of the invention can precisely estimate the concentration of any non-conservative chemical at any location and time.

When calculating a marginal cost of water supply, processes in accordance with various embodiments of the invention can calculate either (or both) the operational cost that is associated with the energy, chemical and other time-varying inputs along the flow paths and the fixed cost that can be proportional to the usage of the water supply infrastructure (e.g., treatment plant, pipeline network, among others) along the flow paths. In various embodiments, for operational cost, the marginal intensity of the attribute (e.g., electricity, chemical, among others) at each location (e.g., consumer, location, appliance, among others) can be calculated and the products of intensity and unit cost (e.g., electricity tariff among others) can be summed together. For fixed costs, the total usage of a component of the infrastructure (e.g., pump, pipe, among others) can be proportional to the total volume of water that passes through the component. The fractional usage of the component by a consumer can be proportional to the fraction of water that passes through the component and is consumed by the consumer over the expected duration of the component's lifetime. In various embodiments, the conversion from this fractional usage to a cost can be based on the depreciation of each infrastructure component as a function of the volume of delivered water. For example, if a $10,000 dollar pump depreciates by $1,000 after delivering (pumping) the first 100 million gallon of water, then an individual consumer would induce a fixed cost of $0.00001 associated with the pump for every gallon of received water that passes through the pump.

When calculating the electricity demand response potential (e.g., value) of a specific location at a specific time, processes in accordance with a variety of embodiments of the invention can calculate energy or energy-associated costs that can be saved or delayed by shedding or shifting water consumption by consumers and adjust elements of the system based on the energy or energy-associated costs. For a UWSS operator who wants to curtail more electricity load with less impact to the water levels in tanks, the most valuable water consumers to incentivize water load shifting can be the ones with highest MEIs during the intended period of demand response. In theory, as long as the pumps in the UWSS are equipped with variable-speed drives (VSDs), the system operator can backtrack the flows into the high-MEI consumers, identify their upstream pumps, and precisely adjust the discharge rate of each pump to match the expected change in water consumption rates of consumers that are targeted and recruited by the demand response activity.

Similarly, when calculating the water demand response potential (e.g., value) of a specific location at a specific time, methods in accordance with numerous embodiments of the invention can be based on the backtracking of water received at each location. For instance, in a fire event, water stored in an adjacent tank would be a critical resource for extinguishing the fire and the system operator of the UWSS would want to incentivize water consumers who received water primarily from the tank to reduce or delay their consumption. In this case, backtracking can be used to calculate the fraction of received water at each location that comes from the critical tank for fire suppression. If we call this fraction r_{crit}, then the consumers with the highest r_{crit} values could be compensated the most for delaying each gallon of water consumption during the fire event.

When determining the value of infrastructure maintenance or upgrades (e.g., fixing leaked pipes) at a specific location, processes in accordance with numerous embodiments of the invention can integrate the marginal value of the concerned attributes of water that is delivered to or passes through the location over time. For example, if the system operator aims to reduce energy intensity of the system by fixing leaked pipes, under a limited budget, he or she may prioritize fixing the pipes through which the leaked water has the highest integrated energy intensities. Since modifications to infrastructure have long-term influence to subsequent operations, the integration of marginal values are no longer real-time values but can be integration of the total volume of otherwise leaked water over the entire operation period after the planned maintenance.

### Hazen-Williams Formula

The Hazen-Williams formula is a classical formula that correlates the head loss with the length, diameter, roughness of a pipe and the flow rate in the pipe. In Eq. 1b below, h is the head loss (m), L is the pipe length (m), Q is the flow rate (m³/s), and d is the pipe diameter (m). C is the roughness coefficient, which is inversely proportional to the roughness of a pipe.

$$h = \frac{10.67 \cdot L \cdot {Q}^{1.852}}{{C}^{1.852} \cdot {d}^{4.87}} \qquad ( 1 b )$$

As Eq. 1 b suggests, longer, thinner, and rougher pipes result in larger head losses. Therefore, by increasing the pipe roughness in the sensitivity analysis, we essentially achieve the same effect as stretching the pipes and expanding the size of the WDN.

Energy-Optimal Siting of Decentralized Water Recycling Systems (DWRS) Decentralized water recycling systems (DWRS) have emerged as a viable strategy for incrementally augmenting water supply in water-stressed regions, but DWRS are generally more energy-intensive than traditional centralized water treatment systems. When DWRS are deployed incrementally in small batches, the marginal energy intensity (MEI) of water supply quantifies the location-specific energy footprint of centralized water supply and serves as a robust metric measuring the energy implications of replacing centralized supply with DWRS supply. Systems and methods in accordance with numerous embodiments of the invention apply an MEI-based decision framework that can identify an energy-optimal siting of DWRS to minimize the overall system operational energy consumption given a target fraction of water demand to be met by newly deployed DWRS. In a small benchmark example water supply system where the energy intensity of the intended DWRS is 5.3% higher than the current system-average energy intensity of centralized supply, an optimal siting of DWRS to offset 10% of system-wide water demand can reduce the overall system energy consumption by 0.77%. In contrast, naïve and worst-case siting of the same DWRS increases the energy consumption of the overall system by 0.65% and 2.0%, respectively. The MEI-based decision framework in accordance with many embodiments of the system can be particularly valuable for application in large multi-source systems where an optimization-based approach is computationally intractable. Many embodiments of the system can account for both distribution and treatment energy intensity when evaluating new water sources and thus provide an energy efficient tool for augmenting water supply.

Evaluating the cost and energy tradeoffs of new water supply sources in water-stressed regions, whether seawater desalination plants, long-distance water transfer, or wastewater reuse facilities, can require a contextualized understanding of the full lifecycle costs of water supply from source acquisition through treatment and distribution for a specific location. The reliability of wastewater supply makes recycling and reusing wastewater an attractive strategy for enhancing water supply resiliency (e.g., ability to quickly recover from disruptions and withstand persistent or severe drought) and reducing the costs of marginal water supply in water-stressed regions. While most urban areas have focused on developing centralized water reuse systems for direct and indirect potable and non-potable reuse, shifts in both technology and policy are beginning to motivate adoption of decentralized water recycling systems (DWRS). There are several unique attributes that distinguish DWRS from supply via centralized or community-scale systems. First, DWRS can be significantly more expensive and energy-intensive than centralized surface water treatment facilities on a volumetric basis. In general, energy intensity range for DWRS systems between 1-10.5 kWh/m, depending on the feed water quality and intended use of the recycled water. Second, while DWRS systems can increase the intensity of the treatment step, they can simultaneously reduce the cost and energy demand associated with transmission, distribution, wastewater collection, regulatory compliance at wastewater treatment facilities, and non-potable distribution infrastructure. Third, as locally recycled water displaces a fraction of water demand that would otherwise be met by the centralized supply system, the locations of DWRS deployment can influence the net energy intensity of meeting the total water demand. Furthermore, DWRS can be deployed incrementally. New centralized supply systems have fixed design volumes, large capital expenditures, and lengthy permitting, design, construction, and start-up phases. In contrast, DWRS can be true ‘marginal’ sources that can be deployed quickly and incrementally at individual end-users.

While regulatory or certification mandates may drive adoption of DWRS systems, it is unclear whether motivating spatially naïve implementation of DWRS represents a beneficial strategy for water utilities. Several frameworks have been developed for minimizing the total costs of hybrid conventional and water reuse supply systems for both municipal and community-scale water recycle facilities. These works have highlighted the importance of accounting for both conveyance and treatment costs in minimizing the total costs and energy intensity of distributed water supply, while addressing the important and challenging question of selecting existing wastewater treatment plants for conversion to utility-scale recycling plants. Accordingly, may embodiments provide for spatially explicit frameworks for minimizing the energy consumption for sub-community (e.g., industrial facility, household, among others) scale DWRS deployment or for selecting energy-optimal locations for DWRS deployment. Here, energy-optimal deployment of DWRS can be the deployment strategy that can minimize the energy consumption of meeting total water demand given a defined fraction of water supplied via newly deployed DWRS.

Accordingly, many embodiments provide a decision framework that can select energy-optimal locations for incremental DWRS deployment by referring to the marginal energy intensity (MEI) of water supply, as discussed throughout. In many embodiments, MEI can quantify the energy intensity of sourcing, treating and transporting water from its origin(s) to a specific consumer at a specific time using one or more flow backtracking algorithms. MEI values can be computed from water flows simulated under a given water supply and demand profile in a water distribution network (WDN) with known configuration. The demand profile can be represented by water consumption rates of consumers throughout a given period (e.g., a week) and the supply profile provides detailed information about the operation of the WDN during the period. The resulting MEI values, which can be spatially and temporally resolved, can include three components corresponding to transmission, treatment and distribution of water. Unlike prior water recycling siting frameworks, many embodiments of the system provide a decision framework that does not involve computationally intensive mathematical optimization or arbitrary pre-selection of candidate locations for DWRS deployment (e.g., limit the deployment locations to a small subset of all feasible locations).

### Theoretical Basis for MEI-Based Selection of Energy-Optimal Locations for DWRS

MEI can be calculated for an individual water consumer whose consumption is negligible relative to system-level consumption. As a result, MEI can be insensitive to changes in the water consumption behavior of the individual consumer and can be used to quantify the energy-saving potential of reducing water withdrawal from the centralized supply system at a specific location. For instance, if the MEI value of a specific consumer is 2 kWh/m³ during an hour with a particular water flow pattern, then a 1 m³ reduction in water withdrawal by that consumer during that hour has an energy-saving potential of 2 kWh. To estimate the annual energy savings from the consumer reducing its water demand by 10% consistently throughout the year, many embodiments multiply the annual reduction in water consumption by the annual MEI value. The annual MEI values can be computed by averaging the water-demand weighted MEI values from individual time steps (e.g., 15 minutes) over the course of a year.

The energy-saving potential per unit volume of recycled water is the difference between the MEI and the energy intensity of the DWRS unit (EI_{DWRS}). Assuming that DWRS are available in modular increments and deployed at a highly decentralized scale (e.g., household scale) that may use negligible energy for distributing the DWRS water, EI_{DWRS} becomes a constant that is invariable across the entire WDN. Therefore, comparing the energy-saving potential of DWRS deployment at different locations becomes equivalent to comparing the MEI values at different locations. Energy-optimal deployment of DWRS entails replacing the most energy-intensive locations for centralized supply with DWRS. As Eq. 1c below indicates, the energy optimality U (an abstract variable) of a location (e.g., consumer) j is positively correlated with the MEI value of delivering water to that location—energy optimality for DWRS deployment occurs at the highest-MEI locations in the WDN. The subsequent impact on total system-wide energy consumption of water supply (ΔEⱼ) is approximately equal to the volume of recycled water delivery at location j (Q_{DWRS,j}) times the difference between the MEI value at the location and EI_{DWRS} (Eq. 2c). This impact is also visualized as the dashed square in the lower right diagram of FIG. 1c.

Uⱼ∝MEIⱼ (1c)

ΔEⱼ≃Q_{DWRS,j}·(EI_{DWRS}−MEIⱼ) (2c)

To account for the possibility that DWRS deployment leads to non-negligible changes in the overall water flow pattern of the distribution system and thus shifts the ranking of high MEI consumer locations, many embodiments of the system can use an iterative algorithm for identifying the locations with the highest post-deployment MEI values. In other words, the energy-optimal locations for DWRS deployment can be those with the highest centralized water supply MEI values after the planned batch of DWRS are deployed.

In addition, the MEI values used for prioritizing locations for DWRS deployment under the goal of minimizing energy consumption for centralized systems may not include the energy dissipation component of MEI since the dissipated energy may not directly contribute to the utility's observed energy consumption or electricity bill. Many embodiments can include energy dissipation in the calculations.

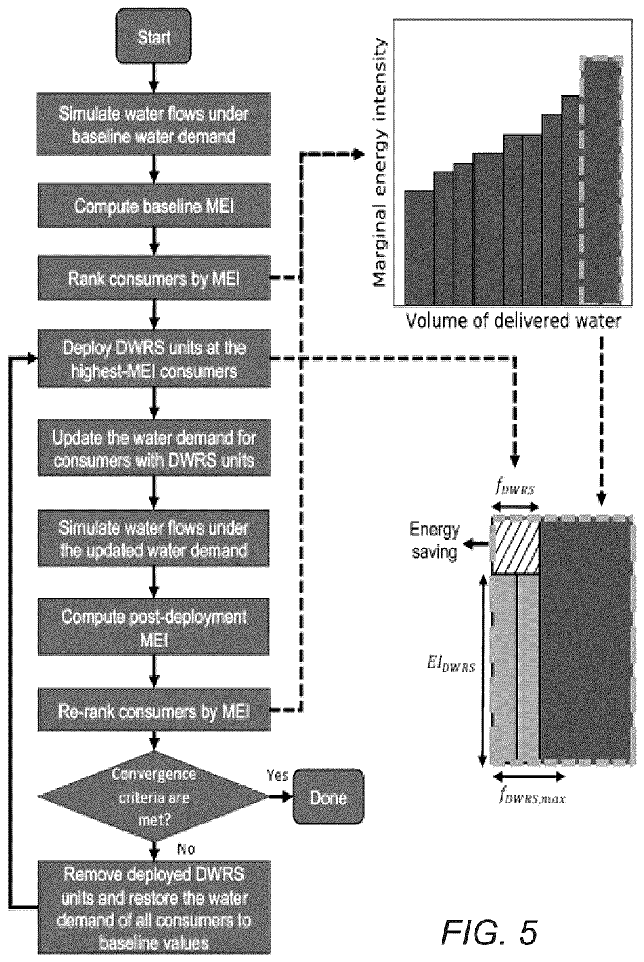

FIG. 5 illustrates an MEI-based decision framework for selecting energy-optimal locations for DWRS deployment. The flow chart describes an iterative algorithm—after the first iteration, each subsequent iteration can involve a tentative deployment of DWRS at the highest-MEI locations, an update to consumer-level water demand met by the centralized supply system, and a re-ranking of consumers by updated MEI values. In many embodiments, the process can converge when the selected consumers for DWRS deployment remain the highest-MEI consumers and the number of deployed DWRS units at each location is unchanged between two subsequent iterations. The two diagrams on the right-hand side illustrate that MEI-ranking is the core of the decision framework and the MEI values measure the energy-saving potential of DWRS deployment at different locations.

### Volumetric Potential for Water Recycling

Both individual consumer water demand characteristics and DWRS characteristics can influence the volume of potential water recycle. First, a consumer's average daily water demand should be greater than the daily capacity of the smallest available DWRS to maximize the use of the distributed system and amortize the capital costs over the largest possible volume. In many embodiments, the system can account for significant capital investments by recommending each installed DWRS unit to operate at its full capacity once deployed. Second, the recovery rate and other technology characteristics of DWRS can generally impose upper bounds on the fraction of water demand that can be offset with a DWRS. This can be important for non-potable water reuse applications where water quality may limit the fraction of total demand that can be met with DWRS. In many embodiments, the framework differentiates between a maximum upper bound fraction, f_{DWRS,max}, and the actual location-specific fraction of demand met by a DWRS, f_{DWRS,j}. Based on Eq. 3c-5c below, the difference between the two f_{DWRS} values stems from the fact that n_{DWRS,j}, the number of deployed DWRS units, must be an integer. Here, Q_{DWRS} is the daily capacity of one DWRS unit and Dⱼ is the average daily demand for centralized supply at location j before DWRS deployment.

n_{DWRS,j}=└Dⱼ·f_{DWRS,max}/q_{DWRS}┘ (3c)

Q_{DWRS,j}=n_{DWRS,j}·q_{DWRS} (4c)

f_{DWRS,j}=Q_{DWRS,j}/Dⱼ (5c)

### Iterative Algorithm for Identifying the Energy-Optimal Locations for DWRS Deployment

In many embodiments, the system minimizes the overall average energy consumption for water supply by selecting a subset of energy-optimal locations K out of the total set of consumers j for DWRS deployment (see Eq. 6c). In Eq. 6c, E_{Tran}, E_{Treat}, and E_{Dist} are system-wide total energy consumption for the transmission, treatment, and distribution of water over a year, which can be simplified by selecting a shorter representative time period (e.g., a week). E_{DWRS,k} is the energy consumption of the DWRS deployed at location k, which meets f_{DWRS,k} of the water demand at k over the same period. Since one cannot deploy half a DWRS unit, f_{DWRS} is less than or equal to f_{DWRS,max}. In many embodiments, DWRS deployment can begin with the highest-MEI consumers and moves to the lower-MEI ones until the target system-wide DWRS capacity is met (see e.g., Eq. 7c). Many embodiments of the system can deploy the largest possible number of DWRS units for each selected consumer (see e.g., Eq. 3c). If a small consumer's average daily water consumption multiplied by f_{DWRS,max} is smaller than the daily capacity of the smallest DWRS unit, the consumer can be skipped for DWRS deployment regardless of its MEI value (i.e., n_{DWRS,j}=0). In Eq. 7c, the system-wide target fraction of water demand to be met by new DWRS is represented as F_{DWRS}. The selection of energy-optimal locations of DWRS deployment can be performed by the iterative algorithm outlined in FIG. 5 in accordance with an embodiment of the invention. To find the locations with the highest post-deployment MEI values, many embodiments of the system can iteratively re-compute the MEI values using the updated water demand met by centralized supply, re-rank the consumers by updated MEI values, and update the deployment of DWRS until the convergence criteria are met. When updating the water demand met by the centralized system, many embodiments of the system can assume that each consumer's f_{DWRS},j value is consistent throughout the simulated period, with on-site water storage balancing the mismatch between the real-time recycling rate of the DWRS units and the real-time consumption rate of recycled water. In other words, many embodiments of the system can reduce the water demand during each time step by f_{DWRS,j}.

Many embodiments of the system can define convergence criterion as consumers selected in the previous iteration (Kⁱ⁻¹) continuing to be selected under the updated post-deployment MEI values (Kⁱ⁻¹=Kⁱ). This stringent criterion could be relaxed for larger WDNs to reduce the number of iterations. For example, an alternative criterion could be that 95% of the locations selected in Kⁱ⁻¹ are preserved in Kⁱ.

$$K ⊆ J {min}_{K} ( {E}_{Tran} + {E}_{Treat} + {E}_{Dist} + {\sum }_{k ∈ K} {E}_{DWRS , k} ) \qquad ( 6 c )$$

$${F}_{DWRS} \cdot {\sum }_{j ∈ J} {D}_{j} = {\sum }_{k ∈ K} {n}_{DWRS , k} \cdot {q}_{DWRS} \qquad ( 7 c )$$

### Computational Framework on a Large-Scale Water Distribution Network

Many embodiments of the system provide a simulated annealing algorithm that optimizes the pumping schedule with respect to electricity prices. In many embodiments, the core of a computational framework can be a rigorous flow backtracking algorithm, which can be optimization-free. In many embodiments, one or more feasible operation schedules, for example a schedule based on records of historical operation or a schedule based on simple heuristics (e.g., tank level-based pump controls), can suffice as an input to the computational framework in accordance with many embodiments of the system. In many embodiments, the flow backtracking process is fully independent of a pump scheduling optimization.

In many embodiments, the flow backtracking algorithm can be primarily solving a system of linear equations consisted of continuous variables. Such computational tasks, even scaled up to have millions of variables, can be readily handled by modern solvers. In other words, systems and methods in accordance with many embodiments can be highly scalable and can be practically adopted by large-scale water supply systems.

An MEI method in accordance with an embodiment of the invention has been deployed to a real-world system that serves approximately 100,000 people and has 10,174 nodes in its hydraulic network model, including 6 injection points and 17 tanks. FIG. 16 illustrates the daily average MEI map for this real-world network to demonstrate the scalability the computational framework in accordance with many embodiments of the invention. In this case, hourly water flow patterns were simulated over a course of 24 hours under the default pump control protocol, which turns each pump on or off as a function of water levels in tanks.

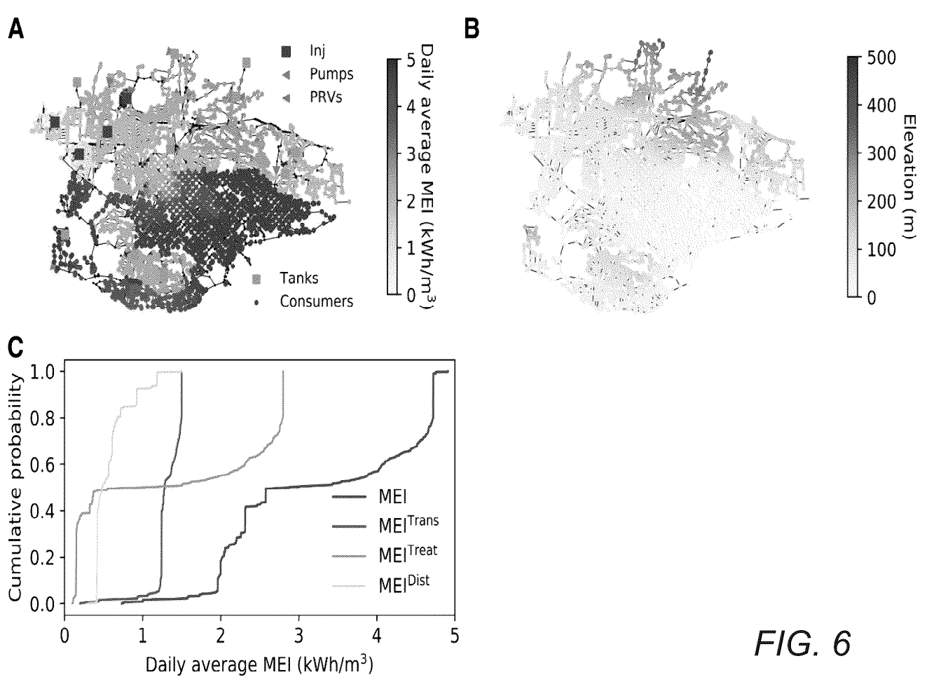

In particular, FIG. 6 illustrates a daily average marginal energy intensity (MEI) across a 10,000+ node water supply system drawing on six diverse water sources (including desalination, non-potable reuse, surface, and groundwater). MEI can be a strong function of the consumer's water sources, associated treatment requirements, and the head and frictional losses associated with network structure. FIG. 6 illustrates that elevation and pressure zones can be poor predictors of marginal energy intensity in complex supply networks. FIG. 6 illustrates contributions of transmission (dark blue), treatment (blue), and distribution (light blue) to total MEI (red) for this system.

In FIG. 6, the lower right section of the network receives primarily desalinated seawater, which contributes to the high MEI values in the section. As FIG. 6 suggests, the highest-MEI locations are concentrated in the low-elevation region. This atypical correlation between elevation and MEI further highlights the importance of a high-resolution metric to measure the energy intensity of water supply. The ‘desalination effect’ can also be observed in FIG. 6, where the upper right section of the cumulative distribution function (CDF) representing the treatment component of MEI corresponds to the subset of consumers who receive most of their water from the seawater desalination plant.

Despite the large network size shown in FIG. 6, the system can be applied with little computational difficulty when applying the MEI method. This can be due to the aforementioned fact that the flow backtracking algorithm is solving a system of linear equations. Moreover, since the flow backtracking algorithm can be applied to simulated water flows during each time step separately, many embodiments can parallelize the flow backtracking computations to multiple CPUs. To generate the plot shown in FIG. 6, for example, many embodiments of the system can use a multi cpu (e.g., 20-CPU) computing cluster to backtrack flows for 96 15-minute time steps and the entire computation takes less than 10 hours. In many embodiments, the majority (>90%) of the computation time can be consumed in compiling the systems of linear equations, rather than solving them. In other words, if we encode the computational framework into a C-language-based software, the lengthy compiling process can be significantly shortened.

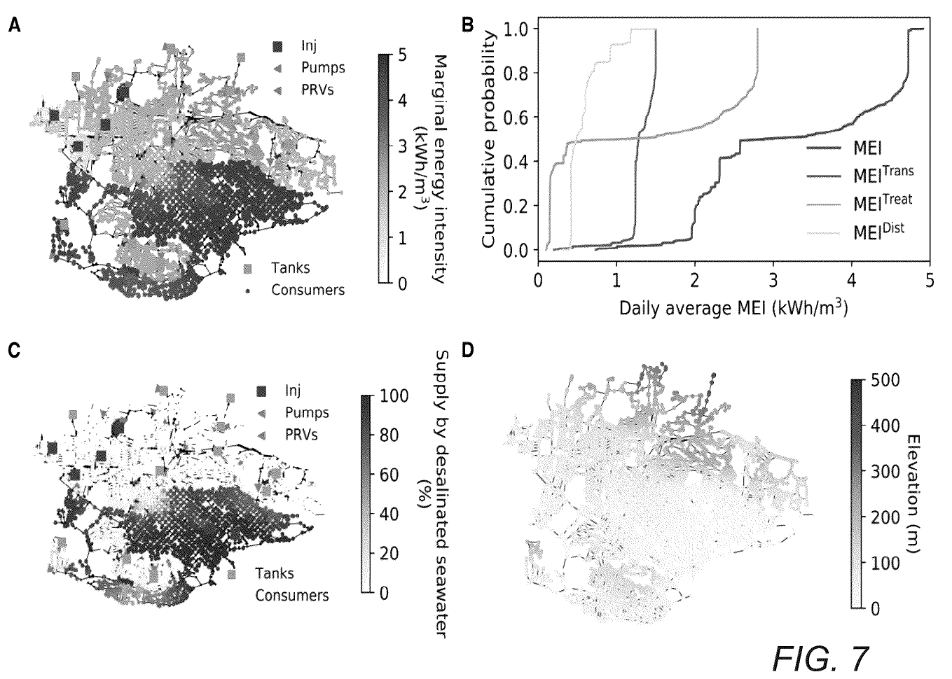

FIG. 7 illustrates drivers of the daily average marginal energy intensity (MEI) of water supply in a city network. FIG. 7 illustrates daily average MEI values in a city, the decomposition of daily average MEI values into components associated with the transmission, treatment, and distribution of water, fraction of daily water demand met by desalinated seawater. As illustrated in FIG. 7, the high-MEI consumers in the city are primarily served by the energy-intensive desalinated seawater. FIG. 7 illustrates the elevation of consumer nodes in the city water supply network. As FIG. 7 illustrates, elevation and pressure zone may not be the key driver of MEI values. In this case, high energy intensity associated with desalinating seawater results in the highest MEI values in the water supply network. Although FIG. 7 illustrates computing a marginal energy intensity value for a particular water supply in a city network, any of a variety of different marginal values can be computed as appropriate to the requirements of specific applications in accordance with embodiments of the invention.

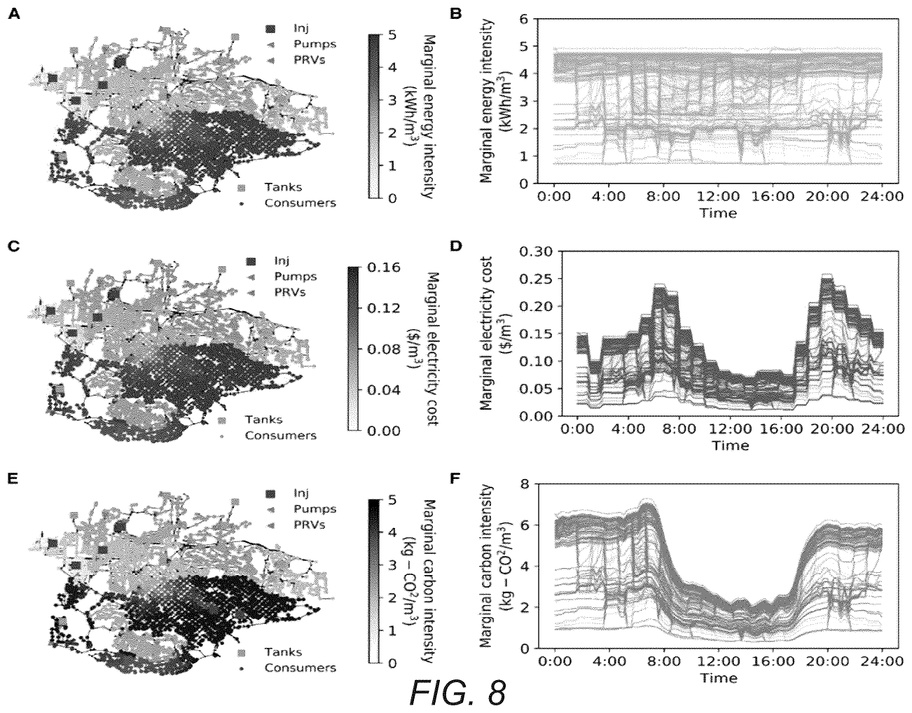

FIG. 8 illustrates a backtracking process for computing various marginal attributes of water supply in an interconnected pipeline network. FIG. 8 illustrates timeseries of marginal attributes in a city water supply network on a particular date. FIG. 8 illustrates daily average MEI values in the water supply network, where the values are computed from real water demand data and water flows simulated under a default pumping protocol. FIG. 8 illustrates timeseries of MEI values for individual consumers over the course of a day, daily average marginal electricity cost (MEC) of water supply in the water supply network. As illustrated, the MEC values can be computed using the locational marginal prices of electricity transmitted to a node (e.g., GOLETA_6_N200). FIG. 8 illustrates timeseries of MEC values for individual consumers over the course of a day, daily average marginal carbon intensity (MCI) of water supply in the network. The MCI values can be computed using a state-average carbon emission factors of electricity supply in CAISO. FIG. 8 illustrates timeseries of MCI values for individual consumers over the course of a day. Although FIG. 8 illustrates computing an MCI value for a particular network, any of a variety of different marginal values can be computed as appropriate to the requirements of specific applications in accordance with embodiments of the invention.

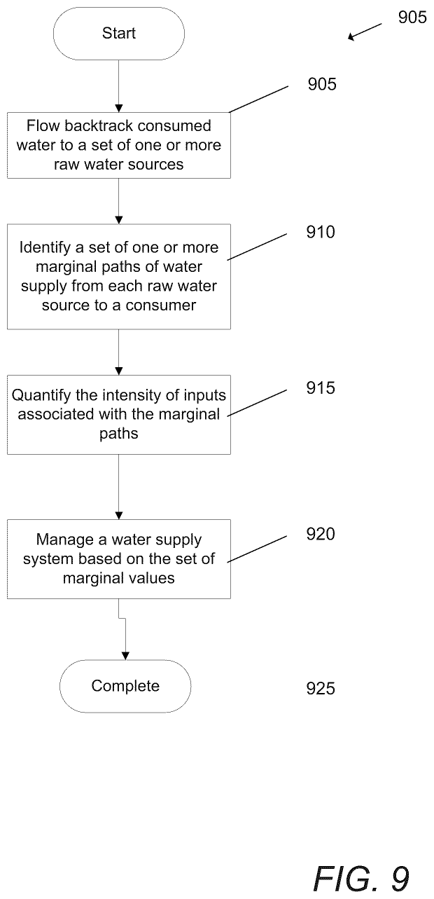

Turning now to FIG. 9, a process for managing and operating a water supply system in accordance with an embodiment of the invention is illustrated. Process 900 can include calculating a set of one or more marginal values for a water supply system by: backtracking 905 consumed water to a set of one or more raw water sources. Process can identify 90 a set of one or more marginal paths of water supply from each raw water source to the consumer. Process can quantify 915 the intensity of inputs associated with the marginal paths. Process can manage 920 the water supply system based on at least the set of marginal values. Process completes. While specific processes for managing and operating a water supply system are described above, any of a variety of processes for managing and operating a water supply system can be utilized as appropriate to the requirements of specific applications in accordance with various embodiments of the invention.

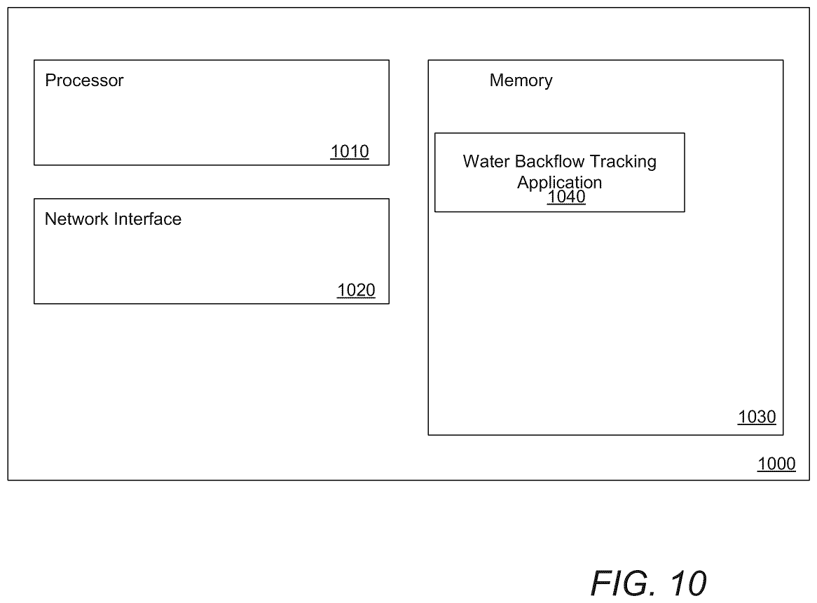

In many embodiments systems and methods for optimizing water system management by calculating marginal attributes of water delivered include a computer system. Turning now to FIG. 10, a computer system for optimizing water system management by calculating marginal attributes of water delivered at specific locations and times in accordance with an embodiment of the invention is illustrated. Computer system 1000 can include a processor 1010. Processors can be any type of logic processing unit, including, but not limited to, central processing units (CPUs), graphics processing units (GPUs), Application Specific Integrated Circuits (ASICs), Field-Programmable Gate-Arrays (FPGAs), and/or any other processing circuitry as appropriate to the requirements of specific applications of embodiments of the invention. Computer system 1000 can further include an input/output (I/O) interface 1020. I/O interfaces can enable connections with external networks and/or devices as required. In numerous embodiments, the I/O interface connects to a display. In a variety of embodiments, the display can be an external device. Computer system 10000 can further include a memory 1030. Memory can be any type of computer readable medium, including, but not limited to, volatile memory, non-volatile memory, a mixture thereof, and/or any other memory type as appropriate to the requirements of specific applications of embodiments of the invention. Memory 1030 can contain an application for calculating marginal attributes of a water. In numerous embodiments, the application can direct the processor to calculate the marginal attributes of water delivered at specific locations times. While specific computer systems for calculating marginal attributes of water are described above, any of a variety of different configurations of computer systems for calculating the marginal attributes of water can be utilized as appropriate to the requirements of specific applications in accordance with various embodiments of the invention.

Although specific Implementations for optimizing water system management by calculating marginal attributes of water are discussed above with respect to FIGS. 1-10, any of a variety of implementations for utilizing the marginal attributes of water can be utilized for in accordance with embodiments of the invention. While the above description contains many specific embodiments of the invention, these should not be construed as limitations on the scope of the invention, but rather as an example of one embodiment thereof. It is therefore to be understood that the present invention may be practice otherwise than specifically described, without departing from the scope and spirit of the present invention. Thus, embodiments of the present invention should be considered in all respects as illustrative and not restrictive.

What is claimed is:

1. A method for managing and operating a water supply system, the method comprising:
calculating a set of one or more marginal values for a water supply system by:
determining a set of transmission marginal values for a transmission stage;
determining a set of treatment marginal values for a treatment stage; and
determining a set of distribution marginal values for a distribution stage for a set of consumers,
wherein determining the set of one or more marginal values comprises:
backtracking consumed water to a set of one or more raw water sources;
identifying a set of one or more marginal paths of water supply from each raw water source to a consumer; and
quantifying the intensity of inputs associated with the marginal paths; and
managing the water supply system based on at least the set of marginal values.

2. The method of claim 1, where backtracking consumed water comprises a simulation of water flows under at least one feasible operation schedule over a period of time.

3. The method of claim 1, wherein the plurality of devices comprises at least one of a pump, treatment process, pipes, and valves.

4. The method of claim 1, wherein the set of one or more marginal values comprises at least one of energy intensity, energy flexibility, demand response potential, carbon intensity, chemical intensity, water age, water quality, and value of infrastructure maintenance/upgrade.

5. The method of claim 1 further comprising calculating an average attribute of the water supply to a subset of water consumers during a period of time by integrating marginal values over location and time.

6. The method of claim 1, wherein backtracking consumed water for paths from the set of raw water sources, comprises treating at least one node as a mixer of upstream inflows.

7. The method of claim 6, wherein the node is a tank that discharges water, wherein backtracking consumed water comprises backtracking historical flows into the tank prior to the current discharge.

8. The method of claim 1, wherein the set of marginal values comprises a marginal energy intensity of water supply to a specific location, wherein integrating the intensity of inputs comprises computing energy consumption by electrical devices and energy dissipation due to frictional and minor losses along the marginal paths; and
wherein the set of marginal values comprises an electricity demand response potential of a specific location at a specific time, wherein integrating the intensity of inputs comprises calculating an energy cost that can be saved by shifting water consumption by consumers.

9. The method of claim 1, wherein the set of marginal values comprises a marginal chemical intensity of water supply, wherein backtracking the consumed water comprises backtracking the chemicals added to the water along the flow paths.

10. The method of claim 1, wherein the set of marginal values comprises a marginal carbon intensity of water supply that fluctuates with time, wherein integrating the intensity of inputs comprises calculating the underlying carbon emission associated with the inputs along the flow paths.

11. The method of claim 1, wherein the set of marginal values comprises a marginal quality of delivered water, wherein integrating the intensity of inputs comprises computing the concentrations of conservative and non-conservative contaminants.

12. The method of claim 1, wherein the set of marginal values comprises a marginal quality of delivered water, wherein integrating the intensity of inputs comprises computing water quality parameters comprising at least one of temperature, color, taste, turbidity, electrical conductivity, major cations and anions, pH, metals, phosphorus, disinfection byproducts, organic material, and fecal coliform.

13. The method of claim 1, wherein the set of marginal values comprises a marginal cost of water supply, wherein integrating the intensity of inputs comprises calculating an operational cost that is associated with time-varying inputs along the flow paths and a fixed cost that is proportional to the usage of the water supply infrastructure along the flow paths.

14. The method of claim 1, wherein the set of marginal values comprises a water demand response potential of a specific location at a specific time, wherein integrating the intensity of inputs comprises backtracking water received at specific locations for a specific time.

15. The method of claim 1, wherein the set of marginal values comprises a value of infrastructure maintenance at a specific location, wherein integrating the intensity of inputs comprises integrating a marginal value of a set of one or more attributes of water that is delivered to or passes through the specific location over time.

16. The method of claim 15, wherein the infrastructure maintenance comprises identifying a set of pipes to replace using computed marginal energy intensity values over a period of time.

17. A system for managing and operating a water supply system, comprising:
a processor; and
memory containing software;
wherein the software directs the processor to:
calculate a set of one or more marginal values for a water supply system by:
determining a set of transmission marginal values for a transmission stage;
determining a set of treatment marginal values for a treatment stage; and
determining a set of distribution marginal values for a distribution stage for a set of consumers,
wherein determining the marginal values for at least one stage comprises:
backtracking consumed water to a set of one or more raw water sources;
identifying a set of one or more marginal paths of water supply from each raw water source to the consumer; and
quantifying the intensity of inputs associated with the marginal paths; and
manage the water supply system based on at least the set of marginal values.

18. The system of claim 17, where backtracking consumed water comprises a simulation of water flows under a feasible operation schedule over a period of time.

19. The system of claim 17, wherein the set of one or more marginal values comprises at least one of energy intensity, energy flexibility, demand response potential, carbon intensity, chemical intensity, water age, water quality, and value of infrastructure maintenance/upgrade.
